(19) United States
(12) Patent Application Publication
(10) Pub. No.: US 2015/0197264 A1
(43) Pub. Date: Jul. 16, 2015

(54) ROLLING BOARD

(71) Applicant: MARK FIELDS, NEW YORK, NY (US)

(72) Inventor: MARK FIELDS, NEW YORK, NY (US)

(21) Appl. No.: 14/340,930

(22) Filed: Jul. 25, 2014

Related U.S. Application Data
(60) Provisional application No. 61/858,790, filed on Jul. 26, 2013.

(51) Int. Cl. B62B 5/00; B62B 5/04; A63C 17/12; A63C 17/14; A63C 17/01

(52) U.S. Cl. CPC B62B 5/0016; A63C 17/1409; A63C 17/017; A63C 17/12; B62B 5/0433; A63C 2017/1463

(57) ABSTRACT

A rolling platform device that can be removably connected to a baby stroller or other rolling conveyance, such as a shopping cart, which enables the operator to propel forward and ride along with the stroller at an increased rate of speed. In embodiments, the rolling platform may be constructed of materials sufficient to support an adult and may also incorporate a braking assembly. In embodiments a wheel assembly is provided that is suitable for high speed operation.

### CROSS-REFERENCE TO RELATED APPLICATION

This application claims benefit of priority of U.S. Provisional Application Ser. No. 61/858,790 titled, “ROLLING BOARD,” filed on Jul. 26, 2013, the content of which is incorporated by reference herein in its entirety.

### FIELD

The present disclosure relates to a rolling platform device that can be removably connected to a baby stroller or other rolling conveyance, such as a shopping cart, and which enables the operator to propel forward and ride along with the stroller at an increased rate of speed.

### SUMMARY OF THE INVENTION

A rolling board according to an exemplary embodiment of the invention is configured to be removably connected to a baby stroller to enable the operator to ride behind, or alongside, the baby stroller. A braking system is provided to slow the device and ultimately, to bring it to a stop.

### BRIEF DESCRIPTION OF THE DRAWINGS

The features and advantages of the disclosure will be more fully understood with reference to the following description of exemplary embodiments of the invention when taken in conjunction with the accompanying figures, which are a graphical representation of the salient elements of the present invention.

FIG. 1 is a perspective view of a rolling board according to an exemplary embodiment of the present invention.

FIG. 2 is a partial bottom plan view of the rolling board of FIG. 1.

FIG. 3 is a partial perspective view of the rolling board of FIG. 1.

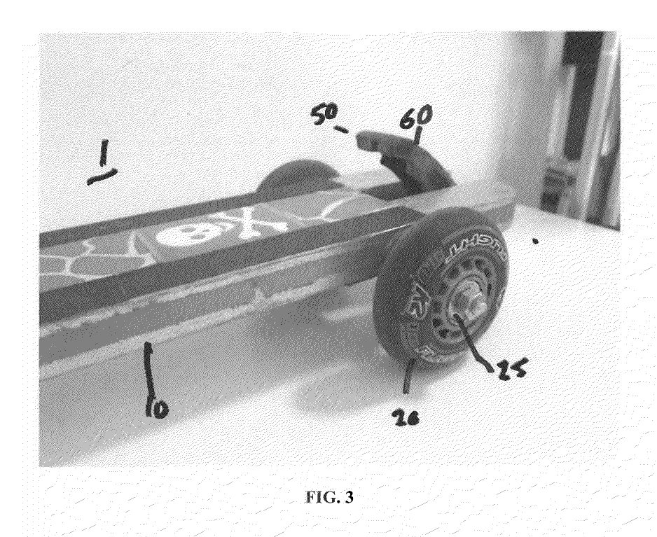

FIG. 4 is a perspective view according to an alternate embodiment of the invention.

### DESCRIPTION

The technology for child stroller design has advanced considerably in recent years. An accessory to many strollers is a rider board that can be attached to the back of a stroller and may rest on two or four wheels. Such a device permits a child alongside or behind the stroller by standing on the platform. Rider boards of the prior art are limited in that they are designed specifically for a child, and not formed of a sufficiently sturdy material, construction, or design to adequately support an adult caregiver. Further, such rider boards are not of sufficient length and design to extend back far enough for the rider to stand in a position such that they have free movement to make long strides with their leg, nor balance properly to stand up in a stable manner, while being free to gain the leverage required to propel the stroller forward by pushing their foot against the ground.

Further still, prior art boards for children also lack a mechanism for slowing the combined board and the stroller, thereby causing a safety risk. These boards of the prior art are further limited in that they use wheel assemblies designed for slow speed and do not enable the operator to move at a higher rate of speed, as would be permissible with a traditional scooter. These rider board wheel assemblies typically allow the wheel to rotate to some degree about a vertical axis.

There is thus a need for a riding board designed in sufficient length, proportion, and of strong materials to support the weight of an adult, and in such a position so as to allow them to gain leverage sufficient to propel the device forward, and operate with stability, control, and quietly at an accelerated rate of speed. There is a further need for a riding board that provides a braking mechanism that is reliable, easy to manufacture, and easy to operate.

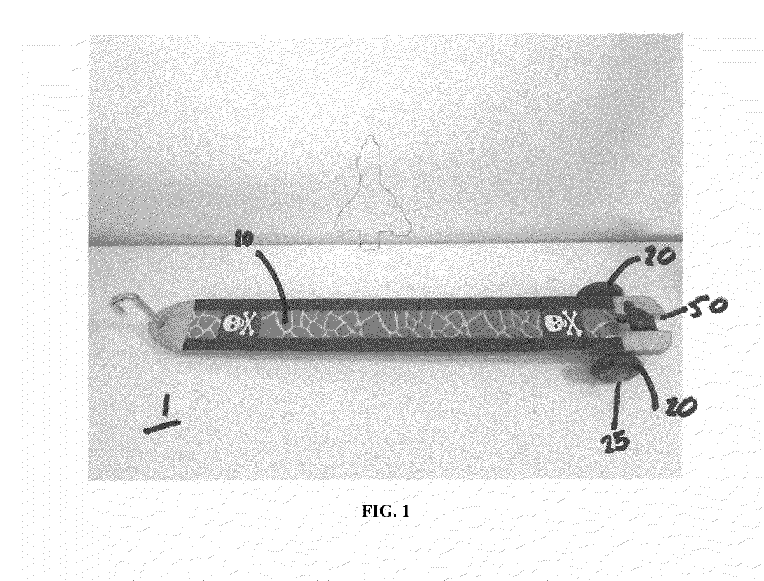

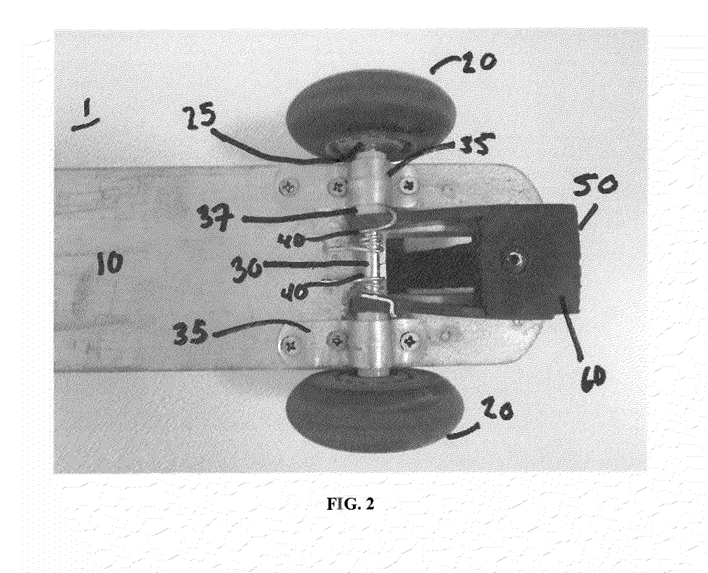

FIGS. 1 and 2 show a rolling board generally designated by the numeral 1. Rolling board 1 may comprise an elongate platform 10 that is uniformly wide and tapers toward the front end. The elongate shape and tapered front provide for a tight and maneuverable turning radius. In embodiments, platform 10 may widen toward the rear to provide a larger, more stable platform for the rider, before again tapering toward the far rear.

In embodiments, wheels 20 are mounted to the underside of board 10, and are of a type conventionally utilized with scooters or inline skates. These wheels provide for smoother movement with less resistance—and therefore higher speed, and a significantly reduced noise level—than the traditional caster wheels found on rider boards of the prior art designed specifically for a child. Wheels 20, each of which comprise a bearing assembly 25 may be attached to a central axle 30, which can be threaded through one or more plastic sleeve spacers 37 that fit over the axle. These sleeve spacers reduce friction between the axle and the mounting hardware, and also provide a larger surface area to allow the wheel clamps to effectively secure the axle to the platform, while providing a gap need to eliminate friction at the contact point of the platform and the wheel.

In embodiments, the junction between wheels 20 and board 10 may take the form of a conventional skateboard truck of a type known in the art.

The wheels 20, bearing assembly 25, axle 30, and sleeve spacers are then mounted to the underside of the board. In embodiments, wheels 20 and central axle are mounted to board 10 by means of mounting hardware such as a bracket 35 that is screwed into board 10, although any lightweight connector means may be used provided that it can support the weight of the operator.

Use of conventional inline skate wheels allows for inexpensive and commoditized replacement parts, which reduces the cost of use over time. For example, wheels 20 may wear out over time and may be replaced with inexpensive parts available from popular suppliers of inline skate parts such as Rollerblade or K2. Similarly, use of conventional inline skate brake pad assembly allows for inexpensive and commoditized replacement parts, which reduces the cost of use over time. For example, brake pad assembly may wear out over time and may be replaced with inexpensive parts available from popular suppliers of inline skate parts such as Rollerblade or K2.

In embodiments, the weight of the operator generates pressure on the contact area of the axle where it meets the underside of the platform 10. To reduce the possibility of deformation to the platform, a contact plate is provided that is attached to the board directly beneath the axle, and effectively distributes the weight across a wider surface area. Contact plate may be formed from any material that will provide support without unduly increasing the weight of the rolling board, such as steel or aluminum.

Since the rolling board is able to move at jogging pace, a brake system 50 may be provided for safety purposes. In exemplary embodiments, slot 55 is provided at the rear end of platform 10 between wheels 20.

Referring to FIG. 2, brake assembly 50 includes brake pad 60, which is spring-mounted on the axle between wheels 20. Brake pad 60 is held in a position such that the brake pad is not in contact with the ground during use until the operator exerts a downward depressive force on the pad. Springs 40—one on each side of the brake pad—may be wrapped around the axle. The two springs provide sufficient and balanced force necessary to hold the brake in the standby position, and allow the user to effect a braking motion with their foot through the application of pressure onto the top of the brake. When the pressure is released, the springs return the brake to the standby position and force of the brake is no longer applied.

Alternatively, in embodiments, a single spring may be employed toward the center of the axle. In further embodiments, an elastic band may be used to maintain the brake pad in then up position.

Springs 40 are biased such that the brake pad defaults to the “up” position and is resistant to the downward pressure of the operator's foot. To brake, the operator depresses the top of brake pad 60, thereby causing the brake pad to make contact with the ground and raise the wheel assembly slightly. Continued pressure causes the wheel assembly to fully lift off the ground with brake pad 60 being the only contact point between the rolling board and the ground. The configuration of brake assembly 50 provides the ability to variably control the braking force depending on the needs of the operator.

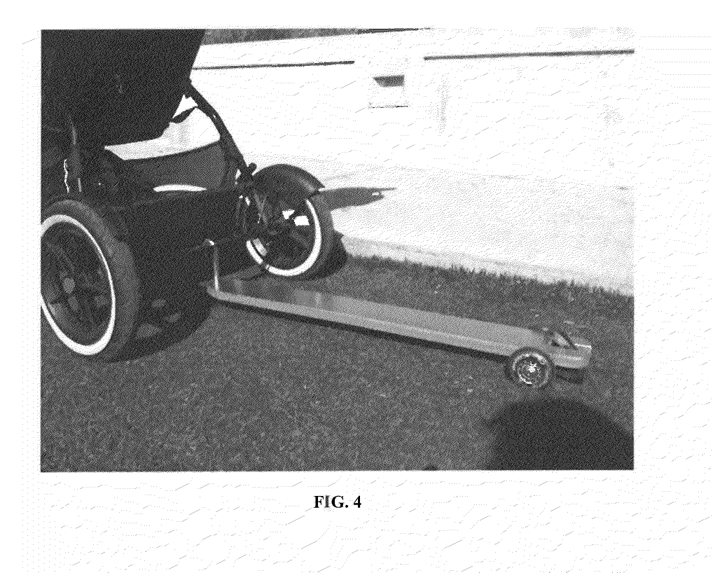

Referring to FIG. 4, a pivotable connector is provided for removably connecting to a stroller or other rolling conveyance. In embodiments, connector may take the form of a hook or adjustable coupling band that may removably attach to the rear axle of a stroller. The rolling board may slide along the rear axle horizontally and attach anywhere to the stroller and need not be in the center. This design feature accommodates rear axles that may be wider in the center because, for example, they have a brake pedal in center. Alternatively, connector may take the form of a band that attaches to the axle of the stroller. Such band may remain rigid and accommodates variations in different types of strollers, including different sizes of the rear axle and different heights of the axle from the ground.

In embodiments, connector may take the form of a hook with a unique, self-adjusting claw design that automatically tightens for a firm grip around the rear axle of a stroller, regardless of its diameter, when weight is applied downward on the platform. When no weight is applied, such as when rider dismounts, the rolling board may then disengage easily such that it may be easily lifted up for storage.

Regardless of the pivot chosen, as the stroller acts as an independent steering wheel for the device, the pivotable connector must have low friction to allow the unit to have the independent freedom of movement required to steer effectively.

The removably attachable connector allows the rolling board to detach quickly and easily from stroller. In embodiments, the rolling board may be folded up when not in use, so stroller may be used in traditional fashion. In embodiments, the folded rolling board may be attached to the stroller handle by way of strap or carabiner to be out of the way when not in use. In embodiments, pivotable connector has a plurality of points of contact with the stroller by means of, for example, multiple hooks or prongs. In further embodiments, pivotable connector mates with a corresponding connector on the stroller. In further embodiments where the stroller lacks a rear axle, pivotable connector may attach to some other element of the stroller, e.g., the rear wheel struts.

Boards of varying shapes, sizes and compositions may be used without departing from the scope of the invention.

In embodiments, the front hook or adjustable coupling band is compatible with a separate “scooter post,” consisting of traditional scooter-style steering handles and a front wheel. This allows for the rolling board to be attached to a stroller or interchangeably attached to the scooter post. This design element effectively creates a standalone scooter that may be used without the stroller. The scooter post has a channel that allows scooter board to slide in to and click to lock in place securely. The operator may depress a spring-loaded pin to easily release and separate the components.

In embodiments, fenders may be provided to cover the wheels that may act as a primary or supplemental braking system. The invention claims a single horizontal bar connecting the two fender-brakes to allow the rider to depress the brake bar so as to effect a braking action on both wheels simultaneously and with equal force.

In embodiments, a meter may be provided for collecting and storing data related to the operation of the device. Metrics such as, for example, maximum speed, average speed, distance traveled of trip, aggregate distance, energy output, and the like may be tracked and displayed for the user, or stored for later review. In embodiments, the data may be transmitted via a wireless link (e.g., Bluetooth) to a user's smartphone for storage, further transmission or review. In further embodiments, meter may download data to internal memory, a flash memory device, or connect directly to a computing device.

In embodiments, meter may comprise a system wherein a magnet embedded in the wheel system triggers a corresponding switch mounted under the elongate board, which passes a signal to a processing device that measures the number of revolutions of the wheel and frequency of those revolutions. In embodiments, processing device may be adjustable to accommodate different wheel sizes and may provide processing, transmission, or display functionality. Any configuration known in the art for measuring the number and frequency of revolutions may be employed and is contemplated as coming within the scope of the present invention.

In embodiments, the braking system may incorporate a resistance generator and battery so that energy may be harvested during the braking process and stored for later use. In embodiments, braking system may include a sensor that responds to user engagement of the brake and directs a motor to operate in the reverse direction to counter the direction of the wheels. The reversal causes the motor to behave as a generator, generating power that may be transmitted to a battery for storage. Conversely, when the rider engages a handle or other control, a motor could provide power from said battery to the wheels so as to push the ride on board and conveyance up hills or when the rider needs an assist to manual accelerating.

In embodiments, a speed control may be integrated such that the device is slowed when a maximum speed is reached, with energy being stored by the battery in the process. In embodiments, meter may indicate that the rolling board has exceeded a preset speed and that the device should be slowed. Meter may then send a signal to the braking system indicating that the device should be slowed and the motor reversal process described above may commence.

It will be understood that any of the elements and/or exemplary embodiments of the disclosure described can be rearranged, separated, and/or combined without deviating from the scope of the disclosure. For ease, various elements are described, at times, separately. This is merely for ease and is in no way meant to be a limitation.

While the various steps, elements, and/or exemplary embodiments of the disclosure have been outlined above, it is evident that many alternatives, modifications and variations will be apparent to those skilled in the art. The various steps, elements, and/or exemplary embodiments of the disclosure, as set forth above, are intended to be illustrative, not limiting. Various changes may be made without departing from the spirit and scope of the disclosure. Accordingly, the spirit and scope of the present disclosure is to be construed broadly and not limited by the foregoing specification.

What is claimed is:

1. A rolling board comprising:
a elongate platform;
a wheel assembly mounted on an underside of said elongate platform, said wheel assembly comprising one or more brackets fixed to said elongate platform, an axle, and one or more wheels attached to said axle;
a braking assembly; and
a pivotable connector for mating said rolling board with a stroller or other conveyance.

2. The rolling board of claim 1 wherein said braking system comprises a brake pad that is held in a standby position until engaged by a downward depressive force.

3. The rolling board of claim 1 further comprising a contact plate fixed between the underside of said elongate board and said one or more brackets.

4. The rolling board of claim 1 wherein said elongate platform tapers toward a front end.

5. The rolling board of claim 1 wherein said elongate platform is configured to support the weight and footprint of an adult.

6. The rolling board of claim 1 wherein a sleeve spacer is fixed on said axle to reduce friction between said axle and said bracket.

7. The rolling board of claim 1 wherein said axle is at least partially housed within an axle sleeve, which is directly attached to said elongate platform.

8. The rolling board of claim 1 wherein said pivotable connector is a hook-type bracket;

9. The rolling board of claim 1 wherein said pivotable connector is a self-adjusting claw that tightens in response to downward pressure on said connector.

10. The rolling board of claim 1 further comprising a second wheel assembly positioned at a front end of said rolling board.

11. The rolling board of claim 1 further comprising one or more fenders over said wheel assembly, said fender operating as a braking system for slowing the rolling board during use.

12. The rolling board of claim 13 further comprising a braking bar for engaging said fenders.

13. The rolling board of claim 1 wherein said elongate platform is configured to removably connect to a scooter post.

14. The rolling board of claim 1 further comprising a meter, wherein said meter collects information on one of current speed, high speed, average speed, distance traveled of trip, and energy expended.

15. The rolling board of claim 1 further comprising a resistance generator and battery for slowing the device or providing a power assist to said wheels.

16. A rolling conveyance comprising:
a stroller comprising one or more wheels, at least one axle joined to said wheels, and a stroller frame;
a rolling board connected to an axle of said stroller, said rolling board comprising:
a semi-rigid elongate platform;
a wheel assembly on an underside of said elongate platform, said wheel assembly comprising one or more brackets fixed to the underside of said elongate platform, an axle, and one or more wheels attached to said axle;
a braking assembly; and
a pivotable connector that connects said rolling board to one of said axles.

17. The rolling conveyance of claim 16 wherein said braking assembly comprises a brake pad that is held in a standby position by one or more springs, and is engaged by a downward depressive force.

18. The rolling conveyance of claim 17 wherein said braking system comprises a brake pad that is held in a standby position by one ore more elastic bands, and is engaged by a downward depressive force.

19. (canceled)

20. A method of operating a rolling conveyance comprising:
providing a rolling board comprising a semi-rigid elongate platform; a wheel assembly on an underside of said elongate platform; a braking assembly and a pivotable connector;
joining said pivotable connector to a rear axle of for mating said rolling board with a stroller or other conveyance;
placing one foot on the top of the rolling board while kicking with the other foot; and
exerting downward force on said braking assembly to slow the device.
